(19) United States
(12) Patent Application Publication
(10) Pub. No.: US 2012/0304235 A1
(43) Pub. Date: Nov. 29, 2012

(54) METHOD AND SYSTEM FOR PLAYING VIDEO FILE, AND MEDIA RESOURCE SERVER

(75) Inventors: Junjie JIA, Shenzhen (CN); Lin Lin, Shenzhen (CN)

(73) Assignee: HUAWEI TECHNOLOGIES CO., LTD.

(21) Appl. No.: 13/568,396

(22) Filed: Aug. 7, 2012

Related U.S. Application Data
(63) Continuation of application No. PCT/CN2011/074241, filed on May 18, 2011.

(30) Foreign Application Priority Data
Nov. 22, 2010 (CN) 201010553781.9

(51) Int. Cl. H04N 21/25

(52) U.S. Cl. 725/93

(57) ABSTRACT

Present invention provide a method, an apparatus, and a system for playing a video file. The method includes: receiving a video playback request sent by a video terminal, where the video playback request carries a video file identity and information about a video media capability of the video terminal; determining that a decoding resource for decoding a video file that corresponds to the video file identity already exists, and using the decoding resource to decode the video file in an internal format; if it is determined that a first encoding resource for obtaining, through encoding, a video file that complies with the video media capability of the video terminal exists, using the first encoding resource to encode the video file in the internal format into a video file that complies with the video media capability of the video terminal, and sending the encoded video file to the video terminal.

### CROSS-REFERENCE TO RELATED APPLICATIONS

This application is a continuation of International Application No. PCT/CN2011/074241, filed on May 18, 2011, which claims priority to Chinese Patent Application No. 201010553781.9, filed on Nov. 22, 2010, both of which are hereby incorporated by reference in their entireties.

### FIELD OF THE INVENTION

Embodiments of the present invention relate to the field of communications technologies, and in particular, to a method and a system for playing a video file, and a media resource server.

### BACKGROUND OF THE INVENTION

In an audio communication system, when a terminal user dials a value-added service, generally a dedicated media resource device needs to provide voice playback, so that a user can obtain interaction information timely, and then performs a next operation according to the interaction information. A most typical service of this type is interactive voice response (Interactive Voice Response, IVR), for example, the 10086 IVR service of China Mobile.

In a video communication system, when a terminal user dials a value-added service, a media resource device needs to have a function of playing video, so that the terminal user can obtain video interaction information. However, because video processing (an encoding process and a decoding process) is more complicated than audio processing, resources occupied by video processing are far more than resources occupied by audio processing. Therefore, it is very important to improve a utilization rate of video encoding/decoding.

Currently, many types of video terminal exist, and video terminals of different types support different encoding/decoding manners. In an existing video communication network, three types of video encoding/decoding manners H.263, MPEG4, and H.264 are widely used. In a video communication system, in addition to a video terminal and a communication system, a video file server and a media resource server are further included. The video file server is configured to store various types of video files that may be played, and the media resource server is configured to acquire a video file from the video file server, perform internal decoding processing of the media resource server, perform encoding processing according to a video encoding/decoding format supported by a video terminal that requests for playback, and then send a video file in an encoding format supported by the video terminal to the video terminal.

When requesting for playing one video file, each video terminal user needs to separately occupy one coder and one decoder of the media resource server. When video encoding/decoding formats supported by multiple video terminals are consistent, and the multiple video terminals request for playing the same video file, the media resource server needs multiple same codecs to encode/decode the same video file. Therefore, huge encoding/decoding resources of the media resource server are wasted, and encoding/decoding efficiency of the media resource server is also low.

### SUMMARY OF THE INVENTION

Embodiments of the present invention provide a method and a system for playing a video file, and a media resource server, which are used to solve a technical problem in the prior art where encoding/decoding resources of the media resource server are wasted and the efficiency is low.

An embodiment of the present invention provides a method for playing a video file, where the method includes:

receiving a video playback request sent by a video terminal, where the video playback request carries a video file identity and information about a video media capability of the video terminal;

determining, according to the video file identity, that a decoding resource for decoding a video file that corresponds to the video file identity already exists, and using the decoding resource to decode the video file that corresponds to the video file identity into a video file in an internal format;

if it is determined, according to the information about the video media capability of the video terminal, that a first encoding resource for obtaining, through encoding, a video file that complies with the video media capability of the video terminal exists, using the first encoding resource to encode the video file in the internal format into a video file that complies with the video media capability of the video terminal, and if it is determined that an encoding resource for obtaining, through encoding, a video file that complies with the video media capability of the video terminal does not exist, allocating a second encoding resource to encode the video file in the internal format into a video file that complies with the video media capability of the video terminal; and

sending the encoded video file that complies with the video media capability of the video terminal to the video terminal.

An embodiment of the present invention provide a media resource server, including:

a video playback request receiving unit, configured to receive a video playback request sent by a video terminal, where the video playback request carries a video file identity and information about a video media capability of the video terminal;

a first determining unit, configured to determine, according to the video file identity, that a decoding resource for decoding a video file that corresponds to the video file identity already exists, and use the decoding resource to decode the video file that corresponds to the video file identity into a video file in an internal format;

a second determining unit, configured to: if it is determined, according to the information about the video media capability of the video terminal, that a first encoding resource for obtaining, through encoding, a video file that complies with the video media capability of the video terminal exists, use the first encoding resource to encode the video file in the internal format into a video file that complies with the video media capability of the video terminal, and if it is determined that the first encoding resource for obtaining, through encoding, a video file that complies with the video media capability of the video terminal does not exist, allocate a second encoding resource to encode the video file in the internal format into a video file that complies with the video media capability of the video terminal; and

a video file sending unit, configured to send the encoded video file that complies with the video media capability of the video terminal to the video terminal.

An embodiment of the present invention provides a system for playing a video file, where the system includes:

a media resource server, configured to: receive a video playback request sent by a video terminal, where the video playback request carries a video file identity and information about a video media capability of the video terminal; determine, according to the video file identity, that a decoding resource for decoding a video file that corresponds to the video file identity already exists, and use the decoding resource to decode the video file that corresponds to the video file identity into a video file in an internal format; if it is determined, according to the information about the video media capability of the video terminal, that a first encoding resource for obtaining, through encoding, a video file that complies with the video media capability of the video terminal exists, use the first encoding resource to encode the video file in the internal format into a video file that complies with the video media capability of the video terminal, and if it is determined that the first encoding resource for obtaining, through encoding, a video file that complies with the video media capability of the video terminal does not exist, allocate a second encoding resource to encode the video file in the internal format into a video file that complies with the video media capability of the video terminal; and send the encoded video file that complies with the video media capability of the video terminal to the video terminal; and

a media file server, configured to receive a video file request sent by the media resource server, where the video file request includes the video file identity, and send the video file that corresponds to the video file identity to the media resource server.

In the embodiments of the present invention, when receiving the video playback request sent by the video terminal, the media resource server needs to judge whether an encoding/decoding resource for encoding/decoding a video file requested by the video terminal already exists locally, and if exists, uses a previously existing encoding/decoding resource. If only a decoding resource for decoding the video file requested by the video terminal exists, but an encoding resource for encoding the video file does not meet a requirement of a video processing capability of the video terminal, a new encoding resource needs further to be allocated to process the video file, which greatly improves utilization efficiency of various encoding/decoding resources of the media resource server, reduces waste of encoding/decoding resources, increases the speed of responding to a video playback request, and improves user experience.

### BRIEF DESCRIPTION OF THE DRAWINGS

To describe the technical solutions in the embodiments of the present invention more clearly, the accompanying drawings required for describing the embodiments are briefly introduced in the following. Apparently, the accompanying drawings in the following description are only some embodiments of the present invention, and persons skilled in the art may derive other accompanying drawings from these accompanying drawings without creative efforts.

FIG. 1 is a flow chart of a method for playing a video file according to an embodiment of the present invention;

FIG. 2 is a flow chart of another method for playing a video file according to an embodiment of the present invention;

FIG. 3 is a schematic diagram of a video image according to an embodiment of the present invention;

FIG. 4 is a schematic structural diagram of a media resource server according to an embodiment of the present invention;

FIG. 5 is a schematic structural diagram of another media resource server according to an embodiment of the present invention; and

FIG. 6 is a schematic structural diagram of a system for playing a video file according to an embodiment of the present invention.

### DETAILED DESCRIPTION OF THE EMBODIMENTS

The technical solutions in the embodiments of the present invention are further described in the following with reference to the accompanying drawings and specific embodiments.

An embodiment of the present invention provides a method for playing a video file, where the method includes:

S101: A media resource server receives a video playback request sent by a video terminal, where the video playback request carries a video file identity and information about a video media capability of the video terminal.

The information about the video media capability may be various, for example, a video encoding/decoding format, an image format, an audio encoding and decoding format, and so on.

S102: If the media resource server determines, according to the video file identity, that a decoding resource for decoding a video file that corresponds to the video file identity already exists, the media resource server uses the decoding resource to decode the video file that corresponds to the video file identity into a video file in an internal format.

If the media resource server determines, according to the video file identity, that a decoding resource for decoding a video file that corresponds to the video file identity does not exist, the media resource server sends a video file request to a video file server, where the video file request includes the video file identity, and then the video file server sends the video file that corresponds to the video file identity to the media resource server. Furthermore, the video file server further needs to allocate a new decoding resource to decode the video file. The decoding resource may perform segmental cyclic decoding on the video file.

The internal format may be a raw data format that is internally universal in the media resource server. The internal format is merely intended to facilitate re-encoding of the media resource server. For different media resource servers, there may be different internal formats.

S103: If the media resource server determines, according to the information about the video media capability of the video terminal, that a first encoding resource for obtaining, through encoding, a video file that complies with the video media capability of the video terminal exists, the media resource server uses the first encoding resource to encode the video file in the internal format into a video file that complies with the video media capability of the video terminal, and if the media resource server determines that the first encoding resource for obtaining, through encoding, a video file that complies with the video media capability of the video terminal does not exist, the media resource server allocates a second encoding resource to encode the video file in the internal format into a video file that complies with the video media capability of the video terminal.

The new coder may further generate an I frame according to a current video image, and send the I frame to a video terminal that uses the new coder.

S104: The media resource server sends the encoded video file that complies with the video media capability of the video terminal to the video terminal.

When receiving the video playback request sent by the video terminal, the media resource server needs to judge whether an encoding/decoding resource for encoding/decoding a video file requested by the video terminal already exist locally, and if exists, uses a previously existing encoding/decoding resource. If only a decoding resource for decoding the video file requested by the video terminal exists, but an encoding resource for encoding the video file does not meet a requirement of a video processing capability of the video terminal, a new encoding resource needs further to be allocated to process the video file, which greatly improves utilization efficiency of various encoding/decoding resources of the media resource server, reduces waste of encoding/decoding resources, increases the speed of responding to a video playback request, and improves user experience.

In video value-added service application, video files played for different users may be the same common video files. In addition, for these specific video files, for example, a fixed video prompt tone, a video wait tone, and a video advertisement, no attention needs to be paid to a start position. If no video terminal accesses to the media resource server, the media resource server may not allocate any encoding/decoding resource. When a video terminal requests that a certain video file be played, the media resource server may allocate a decoding resource (DECODER), and may perform cyclic decoding on the video file into an internal format. The internal format may be a raw data format internally universal in the media resource server. The internal format is merely intended to facilitate re-encoding of the media resource server. For different media resource servers, there may be different internal formats. Furthermore, an encoding resource (CODER) is allocated according to information about a video media capability of the requesting video terminal to encode/decode the video file in the internal format into a stream video file that complies with a video encoding/decoding format and image format that are required by the requesting video terminal, and sends the stream video file to the requesting video terminal. The video terminal plays the stream video file.

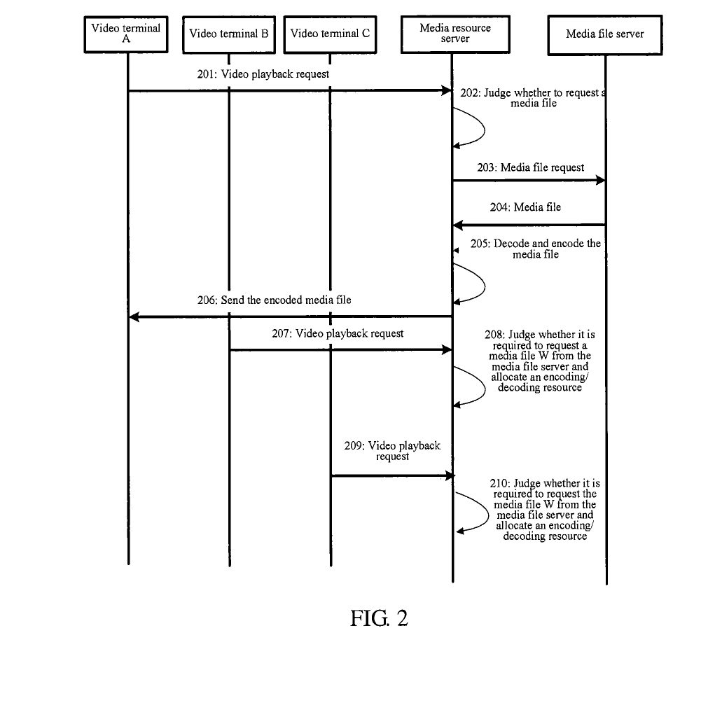

As shown in FIG. 2: A video terminal A and a video terminal B support the same encoding/decoding format and the same image format. For example, the video encoding/decoding format is MPEG4, and the image format is a quarter common intermediate format (Quarter common intermediate format, QCIF). A video encoding/decoding format supported by a video terminal C is H.264, and an image format supported by the video terminal C is CIF. All three video terminals need to request that a video file W be played. Formats of the video file W stored on a video file server are as follows: A video encoding/decoding format is an H.263 format, and an image format is a CIF format. A method for playing a video file is specifically as follows:

S201: A video terminal A sends a video playback request to a media resource server to request that a video file W be played.

The video playback request carries an identity of the video file W and information about a video media capability of the video terminal. The information about the video media capability of the video terminal may include: a video encoding/decoding format type, an audio encoding/decoding format type, and an image format type that are supported by the video terminal A. In addition, in the information about the video media capability, the video encoding/decoding format type and the image format type are mandatory, and the audio encoding/decoding format type is optional. The identity of the video file W may be the name of the video file W, or a code of the video file W, and so on.

In this embodiment, only how to perform video encoding/decoding processing is described. Processing for an image format and audio encoding/decoding format is similar.

S202: After receiving the video playback request, the media resource server judges, according to the video playback request, whether the media resource server needs to request the video file W from a video file server.

When decoding or encoding a video file, the media resource server needs to record which file is decoded or encoded and its format information. Recording may be performed by storing a table such as Table 1. Definitely, another method may be used for recording.

[symbol]

TABLE 1

| | | Format Before | Format After |
|---|---|---|---|
| Video File Identity | Processing Method | Processing | Processing |
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

After receiving the video playback request, the media resource server parses the video playback request to acquire the identity of the video file W, that is, the video terminal A requests that the video file W be played, a video encoding/decoding format supported by the video terminal is MPEG4, and an image format supported by the video terminal is QCIF. An encoding/decoding record, for example, a record on Table 1, is queried in the media resource server, so that it may be known that no decoding record or encoding record about the video file W exists in the media resource server at this time. Therefore, it is determined that the video file W needs to be acquired from the video file server and an encoding/decoding resource needs to be allocated.

S203: The media resource server sends a video file request to the video file server, where the video file request includes the identity of the video file W.

S204: After receiving the video file request, the video file server sends the video file W to the media resource server.

The video file server parses the video file request to obtain the identity of the video file W, and furthermore acquires the video file W, and sends the video file W to the media resource server. A video encoding/decoding format of the video file W is an H.263 format, and an image format of the video file W is a CIF format.

S205: After the media resource server receives the video file W, because both the video encoding/decoding format and the image format of the video file W received from the video file server are different from those requested by the video terminal A, an encoding/decoding resource needs to be allocated to convert the encoding/decoding format and the image format of the video file W into a video file in a video encoding/decoding format and an image format that can be supported by the video terminal A.

After receiving the video file W, the media resource server knows that the video encoding/decoding format of the video file is H.263 and the image format of the video file is CIF, which do not comply with the video media capability of the video terminal A. Therefore, video encoding/decoding format conversion needs to be performed on the video file W, where the video file W is decoded and then encoded. Therefore, the media resource server allocates a decoding resource to decode a video file W in an H.263 format and CIF format. This decoder is an H.263/CIF decoder. Through cyclic decoding by the decoder, a video file W in an internal format may be obtained. In addition, the video encoding/decoding format supported by the video terminal A is MPEG4 and the image format supported by the video terminal A is QCIF. Therefore, the media resource server further allocates an encoding resource, where the encoding resource is an MPEG4/QCIF coder. The MPEG4/QCIF coder replicates the video file W in the internal format, where the video file W in the internal format is decoded by the H.263/CIF decoder, and encodes the video file W in the internal format to obtain a video file in an MPEG4 format and a QCIF image format. After processing for the video file W by the encoding/decoding resource allocated by the media resource server, the media resource server obtains a video file W that complies with a video encoding/decoding format and an image format that are supported by the video terminal A. Definitely, the video file W in the internal format may also be replicated by other modules of the media resource server, and a replicated video file W in an internal format is sent to an MPEG4/QCIF coder newly allocated by the media resource server, which is not restricted here. When the media resource server performs an encoding/decoding operation, the preceding encoding/decoding information is recorded as shown in Table 2.

TABLE 2

| Video File | | Format Before | Format After |
|---|---|---|---|
| Identity | Processing Method | Processing | Processing |
| W | Decoding | H.263/CIF | Internal format |
| W | Encoding | Internal format | MPEG4/QCIF |

The H.263 coder may perform cyclic encoding, and sends an encoded video file W to the video terminal A in a cyclic manner, where the encoded video file W may be played cyclically. Generally, the video file W is a stream video file. Therefore, a cyclically encoded/decoded video file W is encoded/decoded segment by segment. That is, once the H.263/CIF decoder decodes one segment of stream video file W in an H.263 format and a CIF format, MPEG4 encodes one segment of stream video file W in an MPEG4 format and a QCIF format which is a cyclic process. The H.263/CIF decoder and MPEG4/QCIF coder are independent of each other. Therefore, a cyclic decoding process of the H.263/CIF decoder and a cyclic encoding process of the MPEG4/QCIF coder are also independent processes.

In addition, if a memory or a processing capability of the media resource server is large enough, or capacity of the video file W is small, an encoding resource of the media resource server may encode/decode the video file W once, and then stores an encoded/decoded video file in the media resource server. This manner is applicable to processing a common small-capacity video file.

S206: The media resource server sends the stream video file W whose video encoding/decoding format is MPEG4 and image format is QCIF to the video terminal A for playback at the video terminal A.

If a video terminal B at this time also requests the media resource server to play the video file W, and the video terminal also supports that a video encoding/decoding format is MPEG4 and an image format is QCIF.

S207: A video terminal B sends a video playback request to the media resource server to request that the video file W be played.

S208: After receiving the video playback request, the media resource server judges, according to the video playback request, whether the media resource server needs to request the video file W from the video file server and allocate an encoding/decoding resource.

After receiving the video playback request, the media resource server parses the video playback request and knows that the video terminal B requests that the video file W be played, a video encoding/decoding format that may be supported by the video terminal is MPEG4, and an image format that may be supported by the video terminal is QCIF. The media resource server queries content in Table 2 and may know that the media resource server has decoded and encoded the video file W and that the video encoding/decoding format of the encoded video file W is an MPEG4 format and the image format of the encoded video file W is QCIF, which meet a requirement of a video processing capability of the video terminal B. Therefore, the media resource server no longer allocates a new encoding/decoding resource to process the video file W, but uses the decoder and coder that are allocated previously. Furthermore, the media resource server may directly send an encoded video file W in an MPEG4 format and QCIF image format to the video terminal B.

As long as any one terminal is requesting a certain video file, an encoding/decoding resource that corresponds to the video file cannot be released. The encoding/decoding resource that corresponds to the video file is released only if no terminal requests the video file. For example: when the video terminal A stops receiving a video file W, because the video terminal B is still receiving the media file W at this time, the encoding/decoding resource is not released.

If another video terminal C also requests the media resource server to play the video file W, and the video terminal C supports that a video encoding/decoding format is H.264, and an image format is CIF.

S209: A video terminal C sends a video playback request to the media resource server to request that the video file W be played.

S210: After receiving the video playback request, the media resource server judges, according to the video playback request, whether the media resource server needs to request the video file W from the video file server and allocate an encoding/decoding resource.

After receiving the video playback request, the media resource server parses the video playback request and knows that the video terminal C requests that the video file W be played, the video encoding/decoding format that may be supported by the video terminal is H.264, and the image format that may be supported by the video terminal is CIF. The media resource server queries content in Table 2 and may know that the media resource server has decoded and encoded the video file W and that the video encoding/decoding format of the encoded video file W is an MPEG4 format and the image format of the encoded video file W is CIF, which do not meet a requirement of a video processing capability of the video terminal C. Therefore, the media resource server further needs to allocate a new encoding resource, H.264/CIF coder, to process the video file W, and in addition, further needs to use a previously allocated decoding resource.

The H.264/CIF coder newly allocated by the media resource server cyclically replicates a video file W in an internal format. The video file W in the internal format is obtained through cyclic decoding performed by an H.263/CIF decoder on a video file W sent from the video file server. Definitely, the video file W in the internal format may also be replicated by other modules of the media resource server, and then a replicated video file W in an internal format is sent to the H.264/CIF coder newly allocated by the media resource server, which is not restricted here.

When the media resource server performs an encoding operation, the preceding decoding information is recorded, as shown in Table 3.

TABLE 3

| Video File | | Format Before | Format After |
|---|---|---|---|
| Identity | Processing Method | Processing | Processing |
| W | Decoding | H.263/CIF | Internal format |
| W | Encoding | Internal format | MPEG4/QCIF |
| W | Encoding | Internal format | H.264/CIF |

The H.264/CIF coder newly allocated by the media resource server converts the video file W in the internal format into a video file W in a video encoding/decoding format, H.264/CIF format. Furthermore, the media resource server further sends a re-encoded video file W in an H.264/CIF format to the video terminal C.

In addition, the newly added video terminal C and the original video terminal A or B uses the same decoder, that is, on the video terminals A, B, and C, the same media content is watched. A decoder of the media resource server probably performs decoding segment by segment. The video terminal C accesses the media resource server later, and the video terminal A or B accesses the media resource server previously. Therefore, video content watched on the video terminal C is content currently watched on the video terminal A or B.

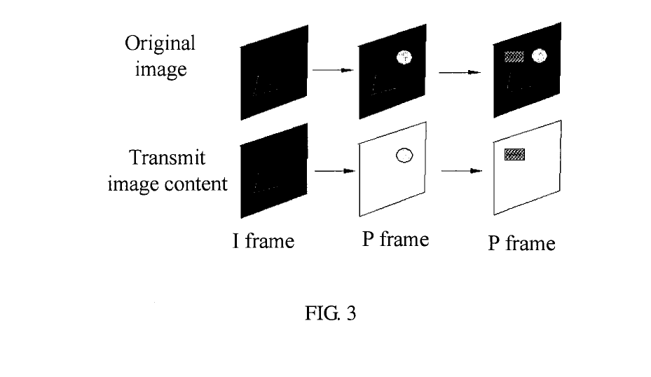

In addition, video encoding/decoding is generally implemented in a full frame (I frame) and predictive frame (P frame) transmission manner, for example, I-P-P-P-I-P-P-I-P . . . , as described in FIG. 3. If I frame data is transmitted at the time when the video terminal C accesses the media resource server, complete video is watched on the video terminal C; if P frame data is transmitted at the time when the video terminal C accesses the media resource server, because no I frame data that corresponds to received P frame data exists, no complete image exists on the video terminal C, which probably causes a large number of mosaic images until a next I frame appears. Therefore, when the video terminal C accesses the media resource server and requests the video file W be played, and the media resource server judges that an H.263/CIF decoder needs to be used, the H.264/CIF coder of the media resource server dynamically generates an I frame according to a current video image, and sends the I frame to each video terminal that uses the H.264/CIF coder, which avoids a problem that a newly accessing user does not watch a clear image at the beginning, and thereby achieving a purpose that a newly accessing video terminal may watch a clear video image immediately.

When receiving a video playback request sent by a video terminal, a media resource server needs to judge whether an encoding/decoding resource for encoding/decoding a video file requested by the video terminal already exist locally, and if exists, uses a previously existing encoding/decoding resource. If only a decoding resource for decoding the video file requested by the video terminal exists, but an encoding resource for encoding the video file does not meet a requirement of a video processing capability of the video terminal, a new encoding resource needs further to be allocated to process the video file, which greatly improves utilization efficiency of various encoding/decoding resources of the media resource server, reduces waste of encoding/decoding resources, increases the speed of responding to a video playback request, and improves user experience.

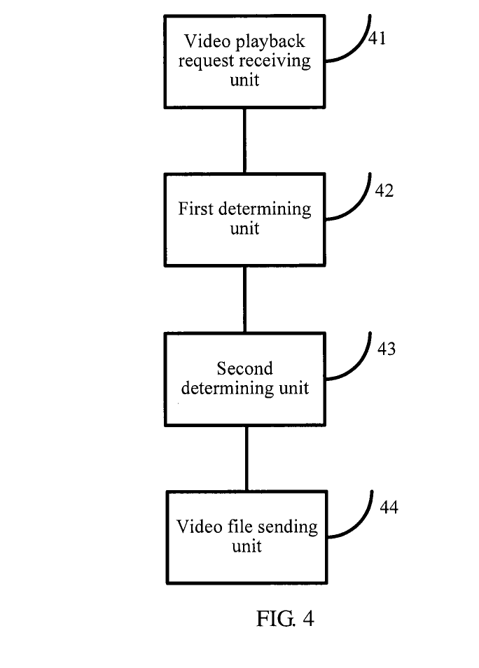

As shown in FIG. 4, an embodiment of the present invention further provides a media resource server, including:

a video playback request receiving unit 41, configured to receive a video playback request sent by a video terminal, where the video playback request carries a video file identity and information about a video media capability of the video terminal;

a first determining unit 42, configured to determine, according to the video file identity, that a decoding resource for decoding a video file that corresponds to the video file identity already exists, and use the decoding resource to decode the video file that corresponds to the video file identity into a video file in an internal format;

a second determining unit 43, configured to: if it is determined, according to the information about the video media capability of the video terminal, that a first encoding resource for obtaining, through encoding, a video file that complies with the video media capability of the video terminal exists, use the first encoding resource to encode the video file in the internal format into a video file that complies with the video media capability of the video terminal, and if it is determined that the first encoding resource for obtaining, through encoding, a video file that complies with the video media capability of the video terminal does not exist, allocate a second encoding resource to encode the video file in the internal format into a video file that complies with the video media capability of the video terminal; and

a video file sending unit 44, configured to send the encoded video file that complies with the video media capability of the video terminal to the video terminal.

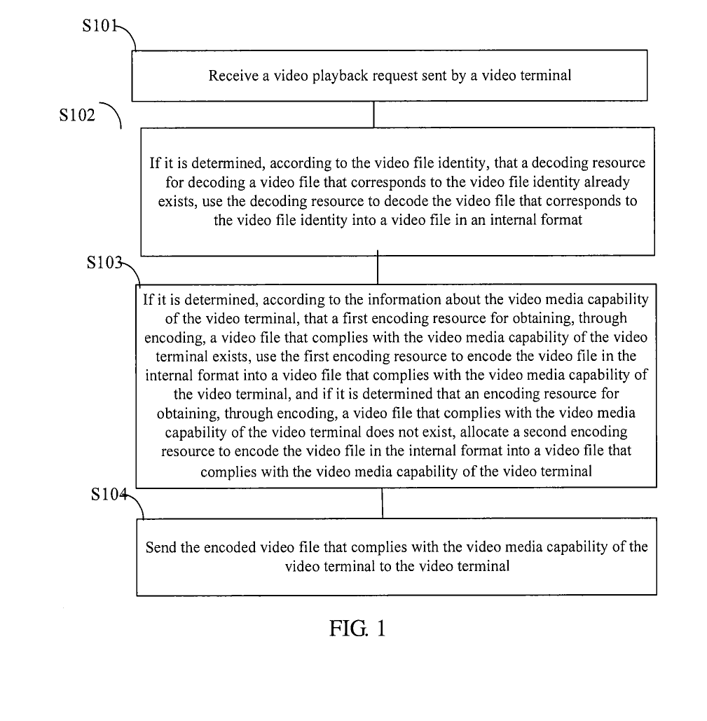

For more than one coder and decoder involved in this embodiment, and involved specific working processes, reference may be made to related content disclosed in the embodiments involved in FIG. 1 to FIG. 3, which are not described herein.

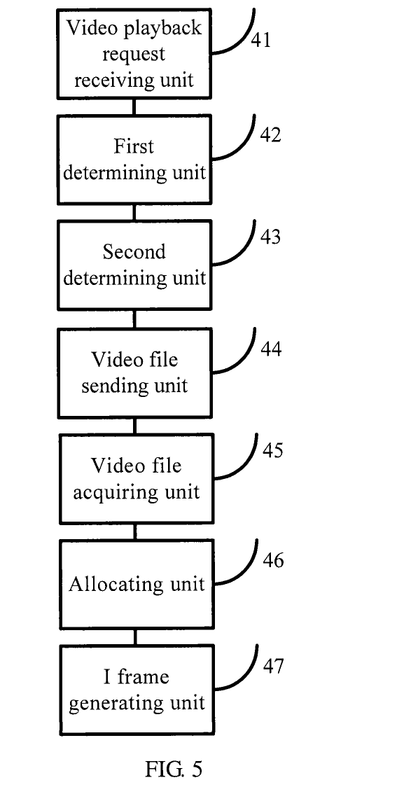

Optionally, as shown in FIG. 5, the preceding media resource server further includes: a video file acquiring unit 45, configured to, when it is determined, according to the video file identity, that a decoding resource for decoding the video file that corresponds to the video file identity does not exist, send a video file request to a video file server, where the video file request includes the video file identity; and receive the video file that corresponds to the video file identity and is sent by the video file server; and

an allocating unit 46, configured to allocate a new encoding/decoding resource to encode/decode the video file.

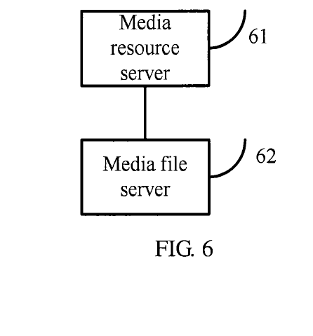

Optionally, as shown in FIG. 6, the preceding media resource server further includes: an I frame generating unit 47, configured to generate, an I frame according to a current video image, and send the I frame to each video terminal that uses the new coder.

When receiving a video playback request sent by a video terminal, a media resource server needs to judge whether an encoding/decoding resource for encoding/decoding a video file requested by the video terminal already exist locally, and if exists, uses a previously existing encoding/decoding resource. If only a decoding resource for decoding the video file requested by the video terminal exists, but an encoding resource for encoding the video file does not meet a requirement of a video processing capability of the video terminal, a new encoding resource needs further to be allocated to process the video file, which greatly improves utilization efficiency of various encoding/decoding resources of the media resource server, reduces waste of encoding/decoding resources, increases the speed of responding to a video playback request, and improves user experience.

As shown in FIG. 6, an embodiment of the present invention further provides a system for playing a video file, where the system includes:

a media resource server 61, configured to: receive a video playback request sent by a video terminal, where the video playback request carries a video file identity and information about a video media capability of the video terminal; determine, according to the video file identity, that a decoding resource for decoding a video file that corresponds to the video file identity already exists, and use the decoding resource to decode the video file that corresponds to the video file identity into a video file in an internal format; if it is determined, according to the information about the video media capability of the video terminal, that a first encoding resource for obtaining, through encoding, a video file that complies with the video media capability of the video terminal exists, use the first encoding resource to encode the video file in the internal format into a video file that complies with the video media capability of the video terminal, and if it is determined that the first encoding resource for obtaining, through encoding, a video file that complies with the video media capability of the video terminal does not exist, allocate a second encoding resource to encode the video file in the internal format into a video file that complies with the video media capability of the video terminal; and send the encoded video file that complies with the video media capability of the video terminal to the video terminal; and

a media file server 62, configured to receive a video file request sent by the media resource server, where the video file request includes the video file identity, and send the video file that corresponds to the video file identity to the media resource server.

Persons skilled in the art may understand that all or a part of steps in the preceding method embodiments may be performed by a program instructing relevant hardware. The program may be stored in a computer-readable storage medium. When the program is executed, the steps in the preceding method embodiments are executed. The storage medium may include any medium capable of storing program codes, such as a ROM, a RAM, a magnetic disk, or a compact disk. Both the preceding charging apparatus and balance management center may be a host device, for example, a PC or a mobile terminal. Where the host device includes a memory that stores a code for executing the present invention, one or multiple microprocessors for executing the code, and a communication interface for providing network access.

Finally, it should be noted that the preceding embodiments are only intended to describe the technical solutions in the present invention, but are not intended to limit the present invention. Persons skilled in the art should understand that modifications may be made to the technical solutions described in the preceding embodiments, or equivalent replacements may be made to some technical features in the technical solutions, however, these modifications and replacements do not make the corresponding technical solutions depart from the spirit and scope of the technical solutions in the embodiments of the present invention.

What is claimed is:

1. A method for playing a video file, comprising:
receiving a video playback request sent by a video terminal, wherein the video playback request carries a video file identity and information about a video media capability of the video terminal;
determining, according to the video file identity, that a decoding resource for decoding a video file that corresponds to the video file identity already exists, and using the decoding resource to decode the video file that corresponds to the video file identity into a video file in an internal format;
if it is determined, according to the information about the video media capability of the video terminal, that a first encoding resource for obtaining, through encoding, a video file that complies with the video media capability of the video terminal exists, using the first encoding resource to encode the video file in the internal format into a video file that complies with the video media capability of the video terminal, and if it is determined that a first encoding resource for obtaining, through encoding, a video file that complies with the video media capability of the video terminal does not exist, allocating a second encoding resource to encode the video file in the internal format into a video file that complies with the video media capability of the video terminal; and
sending the encoded video file that complies with the video media capability of the video terminal to the video terminal.

2. The method according to claim 1, wherein the using the decoding resource to decode the video file that corresponds to the video file identity to a video file in an internal format comprises:
performing, by the decoding resource, cyclic decoding segment by segment on the video file that corresponds to the video file identity into a video file in an internal format.

3. The method according to claim 2, wherein, the using the first encoding resource to encode the video file in the internal format into a video file that complies with the video media capability of the video terminal comprises:
performing, by the first encoding resource, cyclic encoding segment by segment on the video file in the internal format into a video file that complies with the video media capability of the video terminal.

4. The method according to claim 1, further comprising: when determining, according to the video file identity, that a decoding resource for decoding the video file that corresponds to the video file identity does not exist, sending a video file request to a video file server;
receiving the video file that corresponds to the video file identity and is sent by the video file server; and
allocating a new encoding/decoding resource to encode/decode the video file.

5. The method according to claim 1, further comprising: generating, by the second coder, an I frame according to a current video image, and sending the I frame to each video terminal that uses the new coder.

6. A media resource server, comprising:
a video playback request receiving unit, configured to receive a video playback request sent by a video terminal, wherein the video playback request carries a video file identity and information about a video media capability of the video terminal;
a first determining unit, configured to determine, according to the video file identity, that a decoding resource for decoding a video file that corresponds to the video file identity already exists, and use the decoding resource to decode the video file that corresponds to the video file identity into a video file in an internal format;
a second determining unit, configured to: if it is determined, according to the information about the video media capability of the video terminal, that a first encoding resource for obtaining, through encoding, a video file that complies with the video media capability of the video terminal exists, use the first encoding resource to encode the video file in the internal format into a video file that complies with the video media capability of the video terminal, and if it is determined that the first encoding resource for obtaining, through encoding, a video file that complies with the video media capability of the video terminal does not exist, allocate a second encoding resource to encode the video file in the internal format into a video file that complies with the video media capability of the video terminal; and
a video file sending unit, configured to send the encoded video file that complies with the video media capability of the video terminal to the video terminal.

7. The media resource server according to claim 6, further comprising: a video file acquiring unit, configured to, when it is determined, according to the video file identity, that a decoding resource for decoding the video file that corresponds to the video file identity does not exist, send a video file request to a video file server, wherein the video file request comprises the video file identity; and receive the video file that corresponds to the video file identity and is sent by the video file server; and
an allocating unit, configured to allocate a new encoding/decoding resource to encode/decode the video file

8. The media resource server according to claim 6, further comprising: an I frame generating unit, configured to generate an I frame according to a current video image, and send the I frame to each video terminal that uses the new coder.

9. A system for playing a video file, comprising:
a media resource server, configured to: receive a video playback request sent by a video terminal, wherein the video playback request carries a video file identity and information about a video media capability of the video terminal; determine, according to the video file identity, that a decoding resource for decoding a video file that corresponds to the video file identity already exists, and use the decoding resource to decode the video file that corresponds to the video file identity to a video file in an internal format; if it is determined, according to the information about the video media capability of the video terminal, that a first encoding resource for obtaining, through encoding, a video file that complies with the video media capability of the video terminal exists, use the first encoding resource to encode the video file in the internal format into a video file that complies with the video media capability of the video terminal, and if it is determined that the first encoding resource for obtaining, through encoding, a video file that complies with the video media capability of the video terminal does not exist, allocate a second encoding resource to encode the video file in the internal format into a video file that complies with the video media capability of the video terminal; and send the encoded video file that complies with the video media capability of the video terminal to the video terminal; and
a media file server, configured to receive a video file request sent by the media resource server, wherein the video file request comprises the video file identity, and send the video file that corresponds to the video file identity to the media resource server.
